(19) United States
(12) Patent Application Publication
(10) Pub. No.: US 2012/0121925 A1
(43) Pub. Date: May 17, 2012

(54) COATED ARTICLES, ELECTRODEPOSITION BATHS, AND RELATED SYSTEMS

(75) Inventors: Jonathan C. Trenkle, Somerville, MA (US); Christopher A. Schuh, Ashland, MA (US); Alan C. Lund, Ashland, MA (US); John Cahalen, Somerville, MA (US)

(73) Assignee: Xtalic Corporation, Marlborough, MA (US)

(21) Appl. No.: 13/232,291

(22) Filed: Sep. 14, 2011

Related U.S. Application Data
(63) Continuation-in-part of application No. 12/723,020, filed on Mar. 12, 2010.
Application No. 12/723,020 is a continuation-in-part of application No. 12/723,044, filed on Mar. 12, 2010.

(51) Int. Cl. B32B 15/01; C22C 27/04; B32B 5/18; B32B 15/20; B32B 15/00; B32B 15/04; C22C 5/06; C22C 30/00

(52) U.S. Cl. 428/613; 420/501; 420/432; 420/580; 428/671; 428/673; 428/457; 428/332; 428/621; 428/312.8

(57) ABSTRACT

Coated articles, electrodeposition baths, and related systems are described. The article may include a base material and a coating comprising silver formed thereon. In some embodiments, the coating comprises a silver-based alloy, such as a silver-tungsten alloy. The coating can exhibit desirable properties and characteristics such as durability (e.g., wear), hardness, corrosion resistance, and high conductivity, which may be beneficial, for example, in electrical and/or electronic applications. In some cases, the coating may be applied using an electrodeposition process.

### RELATED APPLICATIONS

This application is a continuation-in-part of U.S. application Ser. No. 12/723,020, filed Mar. 12, 2010 and U.S. application Ser. No. 12/723,044, filed Mar. 12, 2010, which are incorporated herein by reference in their entirety.

### FIELD OF INVENTION

The present invention generally relates to coated articles, electrodeposition baths, and related systems. In some embodiments, the coatings are metallic and are electrodeposited.

### BACKGROUND OF INVENTION

Many types of coatings may be applied on a base material. Electrodeposition is a common technique for depositing such coatings. Electrodeposition generally involves applying a voltage to a base material placed in an electrodeposition bath to reduce metal ionic species within the bath which deposit on the base material in the form of a metal, or metal alloy, coating. The voltage may be applied between an anode and a cathode using a power supply. At least one of the anode or cathode may serve as the base material to be coated. In some electrodeposition processes, the voltage may be applied as a complex waveform such as in pulse deposition, alternating current deposition, or reverse-pulse deposition.

Precious metal and precious metal alloy coatings may be deposited using a process such as electrodeposition. In some applications, a coating may at least partially wear off as a result of repeated rubbing against a surface. Such an effect may be undesirable, especially when the coating is applied at least in part to improve electrical conductivity, since this effect can increase the resistance of the coating.

### SUMMARY OF INVENTION

Coated articles, electrodeposition baths, and articles are provided.

In one aspect, a bath is provided. The bath comprises silver ionic species; tungsten and/or molybdenum ionic species; and sodium hydroxide, wherein the bath is suitable for electrodeposition processes.

In another aspect, a bath is provided. The bath comprises silver ionic species; tungsten and/or molybdenum ionic species; and a brightener selected from the group consisting of 2,2-bipyridine and 3-formyl-1-(3-sulphonatopropyl)pyridinium.

In one aspect, an electrodeposition system is provided. The electrodeposition system comprises an anode comprising silver; a cathode; a bath; and a power supply, wherein the bath comprises tungsten and/or molybdenum ionic species and at least one complexing agent, wherein the bath is associated with the anode and the cathode, wherein the power supply is connected to at least one of the anode and the cathode, and wherein the surface area of the anode is at least five times the surface area of the cathode.

In one aspect, an article is provided. The article comprises a base material; and a coating formed on the base material, the coating comprising a silver-based alloy, the silver-based alloy further comprising tungsten and/or molybdenum, the silver-based alloy having a grain size of less than about 100 nm, wherein the grain size changes by no more than 30 nm following exposure to a temperature of at least 125° C. for at least 1000 hours.

In another aspect, an article is provided. The article comprises a base material; a coating formed on the base material, the coating comprising a silver-based alloy, the silver-based alloy further comprising tungsten and/or molybdenum, wherein the concentration of tungsten and/or molybdenum in the silver-based alloy in at least 1.5 atomic percent and the silver-based alloy has an average grain size of less than 1 micron; and a lubricant layer formed on the coating.

In yet another aspect, an article is provided. The article comprises a base material; a coating formed on the base material, the coating comprising a silver-based alloy, the silver-based alloy further comprising tungsten and/or molybdenum; and a lubricant layer formed on the coating, wherein the hardness of the article is greater than about 1 GPa and the coefficient of friction is less than about 0.3.

In still yet another aspect, an article is provided. The article comprises a base material; and a coating formed on the base material, the coating comprising a silver-based alloy, the silver-based alloy further comprising tungsten and/or molybdenum in at least 1.5 atomic percent, wherein the coating has a porosity of at least 10%.

Other aspects, embodiments, and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF THE DRAWINGS

FIG. 1 shows an electrodeposition system according to an embodiment.

FIG. 2 shows an article according to an embodiment.

FIGS. 3A-3B shows images of articles subjected to a durability test A) without and B) with a lubricant layer, according to some embodiments.

FIGS. 4A-4C show scanning electron micrographs of cross sections of electrodeposited silver-alloy coatings comprising A) 2.3 wt %, B) 4.5 wt %, and C) 8.7 wt % tungsten, according to some embodiments.

FIG. 4D shows a plot of the porosity versus wt % of tungsten for electrodeposited silver-tungsten alloys, according to some embodiments.

FIG. 5A shows a plot of the grain size versus tungsten weight percent for electrodeposited silver-tungsten alloys, according to some embodiments.

FIG. 5B shows a plot of the contact resistance versus applied load for an electrodeposited silver-tungsten alloy which was heated to 125° C. for 1000 hours, according to an embodiment.

FIG. 6 shows a plot of silver concentration versus time for electrodeposition baths comprising different anode to cathode surface area ratios, according to some embodiments.

FIG. 7 shows a plot of the tungsten content of an electrodeposited silver-tungsten alloy versus current density, according to some embodiments.

FIG. 8 shows a plot of the pH of electrodeposition baths versus the number of days for a precipitate to be observed in the electrodeposition baths, according to some embodiments.

### DETAILED DESCRIPTION

Coated articles, electrodeposition baths, and related systems are described. The article may include a base material and a coating comprising silver formed thereon. In some embodiments, the coating comprises a silver-based alloy, such as a silver-tungsten alloy. The coating may, in some instances, include at least two layers. For example, the coating may include a first layer comprising a silver-based alloy and a second layer comprising a precious metal. The coating can exhibit desirable properties and characteristics such as durability (e.g., wear), hardness, corrosion resistance, and high conductivity, which may be beneficial, for example, in electrical and/or electronic applications. In some cases, the coating may be applied using an electrodeposition process.

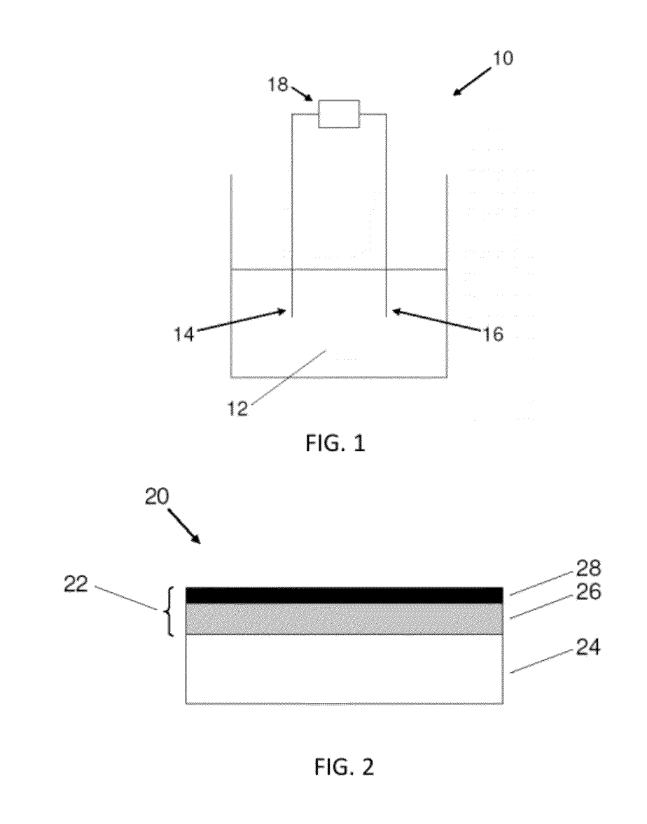

FIG. 1 shows an electrodeposition system 10 according to an embodiment. System 10 includes a electrodeposition bath 12. As described further below, the bath includes the metal sources used to form the coating and one or more additives. An anode 14 and cathode 16 are provided in the bath. A power supply 18 is connected to the anode and the cathode. During use, the power supply generates a waveform which creates a voltage difference between the anode and cathode. The voltage difference leads to reduction of metal ionic species in the bath which deposit in the form of a coating on the cathode, in this embodiment, which also functions as the substrate.

It should be understood that the illustrated system is not intended to be limiting and may include a variety of modifications as known to those of skill in the art.

The electrodeposition baths comprise a fluid carrier for the metal source(s) and additive(s). In some embodiments, the fluid carrier is water (i.e., the bath is an aqueous solution). However, it should be understood that other fluid carriers may also be used such as molten salts, cryogenic solvents, alcohol baths, amongst others. In some embodiments, the fluid carrier is a mixture of water and at least one organic solvent (i.e., an aqueous bath may contain at least some organic solvent). Those of ordinary skill in the art are able to select suitable fluid carriers.

The baths include suitable metal sources for depositing a coating with the desired composition. When depositing a metal alloy, it should be understood that all of the metal constituents in the alloy have sources in the bath. The metal sources are generally ionic species that are dissolved in the fluid carrier. As described further below, during the electrodeposition process, the ionic species are deposited in the form of a metal, or metal alloy, to form the coating. In general, any suitable ionic species can be used. The ionic species may be provided from metal salts. For example, silver nitrate, silver sulfate, silver sulfamate may be used to provide the silver ionic species when depositing a coating comprising silver; sodium tungstate, ammonium tungstate, tungstic acid, etc.

may be used to provide the tungsten ionic species when depositing a coating comprising tungsten. In some cases, the ionic species may comprise molybdenum. Sodium molybdate, ammonium molybdate, molybdenum oxide, etc. may be used to provide the molybdenum ionic species when depositing a coating comprising molybdenum. It should be understood that these ionic species are provided as examples and that many other sources are possible. Any suitable concentration of a metal species may be used, and one of ordinary skill in the art will be able to select a suitable concentration by routine experimentation. In some embodiments, the ionic species in the bath may have a concentration between 0.1 g/L and 100 g/L, between 5 g/L and 50 g/L, or between 1 and 20 g/L.

As described herein, the electrodeposition baths may include one or more additives that may improve the electrodeposition process and/or quality of coatings. For example, the electrodeposition bath may comprise at least one complexing agent (i.e., a complexing agent or mixture of complexing agents). A complexing agent refers to any species which can coordinate with the ions contained in the solution. In some embodiments, a complexing agent or mixture of complexing agents may permit codeposition of at least two elements. For example, a complexing agent or mixture of complexing agents may permit codeposition of silver and tungsten.

The complexing agent may be an organic species, such as a citrate ion, a compound comprising a hydantoin, an imide functional group, or a substituted pyridine compound. The complexing agent may be an inorganic species, such as an ammonium ion. In some cases, the complexing agent is a neutral species. In some cases, the complexing agent is a charged species (e.g., negatively charged ion, positively charged ion). Examples of complexing agents include citrates, gluconates, tartrates, and other alkyl hydroxyl carboxylic acids; cyanide; hydantoins (e.g., 5,5-dimethylhydantoin), succinimides (e.g., succinimide), and other compounds comprising an imide functional group; and substituted pyridine compounds (e.g., nicotinamide).

Generally, a complexing agent, or mixture of complexing agents, may be included in the electrodeposition bath within a concentration range of 0.1-200 g/L, and, in some cases, within the range of 40-80 g/L. In one embodiment, the mixture of complexing agents comprises 5,5-dimethylhydantoin, citric acid, and nicotinamide. When the complexing agent is a compound comprising an imide functional group, the concentration of the complexing agent may be within the range 30-70 g/L or 40-60 g/L. When the complexing agent is an alkyl hydroxyl carboxylic acid, the concentration of the complexing agent may, in some instances, be within the range 1-20 g/L or 5-15 g/L. When the complexing agent is a substituted pyridine compound, the concentration of the complexing agent may, in some instances, be within the range 0.5-20 g/L or 0.5-5 g/L. When the complexing agent is a hydantoin, the concentration of the complexing agent may, in some instances, be within the range of 50-70 g/L. Concentrations outside these ranges may be used, and those of ordinary skill in the art will readily be able to determine suitable concentrations by routine experimentation.

In some embodiments, ammonium ions may be incorporated into the electrolyte bath as complexing agents and to adjust solution pH. For example, the electrodeposition bath may comprise ammonium ions in the range of 1-50 g/L, and within the range of 10-30 g/L. Other concentration ranges may also be suitable.

In some cases, the baths may include at least one wetting agent. A wetting agent refers to any species capable of reducing the surface tension of the electrodeposition bath and/or increasing the ability of gas bubbles to detach from surfaces in the bath. For example, the substrate may comprise a hydrophilic surface, and the wetting agent may enhance the compatibility (e.g., wettability) of the bath relative to the substrate. In some cases, the wetting agent may also reduce the number of defects within the metal coating that is produced. The wetting agent may comprise an organic species, an inorganic species, an organometallic species, or combinations thereof. In some embodiments, the wetting agent may be selected to exhibit compatibility (e.g., solubility) with the electrodeposition bath and components thereof. For example, the wetting agent may be selected to include one or more hydrophilic species, including amines, thiols, alcohols, carboxylic acids and carboxylates, sulfates, phosphates, polyethylene glycols (PEGs), or derivatives of polyethylene glycol, to enhance the water solubility of the wetting agent. In some embodiments, the wetting agent may comprise a fluorosurfactant. In some embodiments, the wetting agent may include Zonyl® FSJ (Dupont), Captsone™ (Dupont), or Triton™ QS-15 (Dow).

Any suitable concentration of wetting agent may be used. For example, the concentration of wetting agent may be between 10 microliters/L and 2000 microliters/L, between 20 microliters/L and 1000 microliters/L, or between 50 microliters/L and 500 microliters/L. Other concentration ranges may also be suitable.

In some embodiments, the baths may include at least one brightening agent. The brightening agent may be any species that, when included in the baths described herein, improves the brightness and/or smoothness of the electrodeposited coating produced. In some cases, the brightening agent is a neutral species. In some cases, the brightening agent comprises a charged species (e.g., a positively charged ion, a negatively charged ion). In one set of embodiments, the brightening agent may comprise at least one pyridine ring or at least one pyridinium ring. In some embodiments, the brightening agent comprises bipyridine, optionally substituted.

Any suitable concentration of brightening agent may be used. For example, the concentration of brightening agent may be between 0.01 g/L and 50 g/L, between 0.01 g/L and 10 g/L, between 0.1 g/L and 5 g/L, or between 0.1 g/L and 1 g/L. Other concentration ranges may also be suitable.

In some embodiments, the brightening agent is 2,2-bipyridine or 3-formyl-1-(3-sulphonatopropyl)pyridinium. The concentration of 2,2-bipyridine in the bath may be between about 0.1 g/L and about 5 g/L, or between 0.1 g/L and about 1 g/L, or between about 0.1 g/L and about 0.8 g/L. In a particular embodiment, the brightening agent is 2,2,-bipyridine at a concentration between about 0.2 g/L and about 0.6 g/L. In a particular embodiment, the brightening agent is 3-formyl-1-(3-sulphonatopropyl)pyridinium at a concentration of about 2 g/L. In one embodiment, an electrodeposition bath comprises 2,2-pyridine as the brightening agent and Triton™ QS-15 (Dow) as the wetting agent.

Those of ordinary skill in the art would be able to select the appropriate combination of ionic species, wetting agent, complexing agent and/or other additives (e.g., brightening agents) suitable for use in a particular application. Generally, the additives in a bath are compatible with electrodeposition processes, i.e., a bath may be suitable for electrodeposition processes. One of ordinary skill in the art would be able to recognize a bath that is suitable for electrodeposition processes Likewise, one of ordinary skill in the art would be able to recognize additives that, when added to a bath, would make the bath not suitable for electrodeposition processes.

In some aspects, various techniques can be used to monitor the contents of the electrodeposition baths. For example, the techniques may determine the concentration of one or more of the additives in the bath such as the brightening agent(s), wetting agent(s), complexing agent(s), etc. If the concentration of the additive(s) is below or above a desired concentration, the bath composition may be adjusted so that the concentration lies within the desired range.

The pH of the electrodeposition bath can be from about 2.0 to 12.0. In some cases, the electrodeposition bath may have a pH from about 7.0 to 9.0, or, in some cases, from about 7.6 to 8.4, or, in some cases, from about 7.9 to 8.1. However, it should be understood that the pH may be outside the above-noted ranges. The pH of the bath may be adjusted using any suitable agent known to those of ordinary skill in the art. In some embodiments, the pH of the bath is adjusted using a base, such as a hydroxide salt (e.g., potassium hydroxide). In some embodiments, the pH of the bath is adjusted using an acid (e.g., nitric acid).

In some embodiments, the electrodeposition bath comprises a hydroxide salt. In a particular embodiment, the hydroxide salt is sodium hydroxide. In some cases, the hydroxide salt is not potassium hydroxide. Without wishing to be bound by theory, the use of sodium hydroxide as compared to use of potassium hydroxide in an electrodeposition bath may be advantageous, as it may reduce and/or prevent formation of precipitates in the solution. For example, in one embodiment, when employing an electrodeposition bath comprising potassium hydroxide, a tungsten oxide precipitate was observed, while no precipitate was observed under substantially similar conditions using sodium hydroxide. In some cases, when using sodium hydroxide, the electrodeposition bath may have a pH greater than about 6.5 to 9.0. In some cases, the pH is between about 6.5 and about 9.5, between about 6.5 and about 8.5, between about 7.0 and about 8.5, or between about 6.5 and 8.0. In some cases, the pH is less than 9.0, less than 8.5, or less than 8.0.

In one embodiment, an electrodeposition bath comprises between about 8 to about 9 g/L silver ionic species, around about 27 g/L tungsten ionic species, and has a pH less than about 8, greater than about 6.5, or between about 6.5 and 8. In another embodiment, an electrodeposition bath comprises between about 4 to about 5 g/L silver ionic species, around about 60 g/L tungsten ionic species, and has a pH less than about 8.5, greater than about 6.5, or between about 6.5 and 8.5.

In some cases, the operating range for the electrodeposition baths described herein is 5-100° C., 10-70° C., 10-30° C., 25-80° C., or, in some cases, 40-70° C. In some cases, the temperature is less than 80° C. However, it should be understood that other temperature ranges may also be suitable.

In general, the electrodeposition baths can be used in connection with any electrodeposition process. Electrodeposition generally involves the deposition of a coating on a substrate by contacting the substrate with an electrodeposition bath and flowing electrical current between two electrodes through the electrodeposition bath, i.e., due to a difference in electrical potential between the two electrodes. For example, methods described herein may involve providing an anode, a cathode, an electrodeposition bath associated with (e.g., in contact with) the anode and cathode, and a power supply connected to the anode and cathode. In some cases, the power supply may be driven to generate a waveform for producing a coating, as described more fully below. In some embodiments, at least one electrode may serve as the substrate to be coated.

In some embodiments, an electrodeposition system comprises an anode, a cathode, a bath, and a power supply connected to at least one of the anode and the cathode. In some cases, the anode comprises silver (e.g., wherein the anode provides silver ionic species to the bath) and the bath comprises tungsten and/or molybdenum ionic species and optionally, at least one complexing agent and/or other additives. In such embodiments, the surface area of the anode to the surface area of the cathode may be selected so as to provide an appropriate amount of silver ionic species to the bath. Without wishing to be bound by theory, in embodiments wherein the ratio of the anode surface area to the cathode surface area is too small, the anode may passivate and the silver ionic species in the solution may not be replenished. In some cases, the surface area of the anode (e.g. comprising silver) is at least about 5 times, at least about 6 times, at least about 7 times, at least about 8 times, at least about 9 times, or at least about 10 times, the surface area of the cathode. In a particular embodiment, the surface area of the anode is at least about 5 times the surface area of the cathode.

An anode comprising silver may be formed essentially of silver (e.g., greater than 95% silver, greater than 97% silver, greater than 98% silver, greater than 99% silver, greater than 99.5% silver, greater than 99.9% silver), or may not be formed essentially of silver. In some cases, an anode comprising silver may comprise silver formed on a substrate (e.g., a conductive substrate). In some cases, an anode comprising silver may also comprise at least one additional metal (e.g., tungsten), wherein each of the additional metals may or may not provide metal ionic species to the bath (e.g., tungsten ionic species).

In general, during an electrodeposition process an electrical potential may exist on the substrate to be coated, and changes in applied voltage, current, or current density may result in changes to the electrical potential on the substrate. In some cases, the electrodeposition process may include the use of waveforms comprising one or more segments, wherein each segment involves a particular set of electrodeposition conditions (e.g., current density, current duration, electrodeposition bath temperature, etc.). The waveform may have any shape, including square waveforms, non-square waveforms of arbitrary shape, and the like. In some methods, such as when forming coatings having different portions, the waveform may have different segments used to form the different portions. However, it should be understood that not all methods use waveforms having different segments.

In some embodiments, a coating, or portion thereof, may be electrodeposited using direct current (DC) deposition. For example, a constant, steady electrical current may be passed through the electrodeposition bath to produce a coating, or portion thereof, on the substrate. In some embodiments, the potential that is applied between the electrodes (e.g., potential control or voltage control) and/or the current or current density that is allowed to flow (e.g., current or current density control) may be varied. For example, pulses, oscillations, and/or other variations in voltage, potential, current, and/or current density, may be incorporated during the electrodeposition process. In some embodiments, pulses of controlled voltage may be alternated with pulses of controlled current or current density. In some embodiments, the coating may be formed (e.g., electrodeposited) using pulsed current electrodeposition, reverse pulse current electrodeposition, or combinations thereof.

In some cases, a bipolar waveform may be used, comprising at least one forward pulse and at least one reverse pulse, i.e., a “reverse pulse sequence.” As noted above, the electrodeposition baths described herein are particularly well suited for depositing coatings using complex waveforms such as reverse pulse sequences. In some embodiments, the at least one reverse pulse immediately follows the at least one forward pulse. In some embodiments, the at least one forward pulse immediately follows the at least one reverse pulse. In some cases, the bipolar waveform includes multiple forward pulses and reverse pulses. Some embodiments may include a bipolar waveform comprising multiple forward pulses and reverse pulses, each pulse having a specific current density and duration. In some cases, the use of a reverse pulse sequence may allow for modulation of composition and/or grain size of the coating that is produced.

A coating may be applied using an electrodeposition process at a current density of at least 0.001 A/cm², at least 0.01 A/cm², or at least 0.02 A/cm². Current densities outside these ranges may be used as well. In some cases, a direct current is employed having a direct current density of greater than about 10 mA/cm², greater than about 15 mA/cm², greater than about 20 mA/cm², greater than about 30 mA/cm², or greater than about 50 mA/cm². In some embodiments, a direct current density is greater than about 15 mA/cm², and at current densities below this level, only silver is deposited.

For current which is applied in pulses, the frequency may be any suitable frequency (e.g., between 0.1 Hertz and about 100 Hz). Similarly, the voltage may be any suitable voltage (e.g., between about 0.1 V and about 1 V).

The deposition rate of the coating may be controlled. In some instances, the deposition rate may be at least 0.1 microns/minute, at least 0.3 microns/minute, at least 1 micron/minute, or at least 3 microns/minute. Deposition rates outside these ranges may be used as well.

Those of ordinary skill in the art would recognize that the electrodeposition processes described herein are distinguishable from electroless processes which primarily, or entirely, use chemical reducing agents to deposit the coating, rather than an applied voltage. The electrodeposition baths described herein may be substantially free of chemical reducing agents that would deposit coatings, for example, in the absence of an applied voltage.

The electrodeposition systems/methods may utilize certain aspects of methods/systems described in U.S. Patent Publication No. 2006/02722949, entitled “Method for Producing Alloy Deposits and Controlling the Nanostructure Thereof using Negative Current Pulsing Electro-deposition, and Articles Incorporating Such Deposits,” which is incorporated herein by reference in its entirety. Aspects of other electrodeposition methods/systems may also be suitable including those described in U.S. Patent Publication No. 2006/0154084 and U.S. application Ser. No. 11/985,569, entitled “Methods for Tailoring the Surface Topography of a Nanocrystalline or Amorphous Metal or Alloy and Articles Formed by Such Methods”, filed Nov. 15, 2007; U.S. Patent Publication No. 20090286103 and U.S. patent application Ser. No. 12/120,564, filed May 14, 2008; U.S. application Ser. No. 12/723,020, entitled “Electrodeposition

Baths and Systems”, filed Mar. 12, 2010; and U.S. application Ser. No. 12/723,044, entitled “Coated Articles and Methods”, filed Mar. 12, 2010 which are incorporated herein by reference in their entireties.

FIG. 2 shows an article 20 according to an embodiment. The article has a coating 22 formed on a base material 24. In some embodiments, the coating comprises a plurality of layers. In some embodiments, the coating may comprise a first layer 26 formed on the base material and a second layer 28 formed on the first layer. Each layer may be applied using a suitable process, as described in more detail below. It should be understood that the coating may include more than two layers. It should also be understood that the coating may include only one layer. However, in some embodiments, the coating may only include two layers, as shown. In some cases, the coating may be formed on at least a portion of the substrate surface. In other cases, the coating covers the entire substrate surface.

In some embodiments, the coating comprises one or more metals. For example, the coating may comprise a metal alloy. In some cases, alloys that comprise silver (i.e., silver-based alloys) are preferred. Such alloys may also comprise tungsten and/or molybdenum. Silver-tungsten alloys may be preferred in some cases. In some cases, the atomic percent of tungsten and/or molybdenum in the alloy may be between 0.1 atomic percent and 50 atomic percent; and, in some cases, between 0.1 atomic percent and 20 atomic percent. In some embodiments, the atomic percent of tungsten and/or molybdenum in the alloy may be at least 0.1 atomic percent, at least 1 atomic percent, at least 1.5 atomic percent, at least 5 atomic percent, at least 10 atomic percent, or at least 20 atomic percent. Other atomic percentages outside of this range may be used as well.

In some embodiments, the silver-based alloy may form first layer 26 of the coating. In some embodiments, second layer 28 comprising one or more precious metals may form a second layer of the coating. In some cases, the first layer comprising a silver alloy is formed on the base material, and the second layer comprising one or more precious metals is formed on the first layer. Examples of suitable precious metals include Ru, Os, Rh, Re, Ir, Pd, Pt, Ag, Au, or any combination thereof. Gold may be preferred in some embodiments. In some embodiments, a layer consists essentially of one precious metal. In some embodiments, it may be preferable that a layer (e.g., the second layer) is free of tin. In other cases, a layer may comprise an alloy that includes at least one precious metal and at least one other element. The element may be selected from Ni, W, Fe, B, S, Co, Mo, Cu, Cr, Zn, and Sn, amongst others. For example, a layer may comprise a Ni—Pd alloy, a Au—Co alloy, and/or a Au—Ni alloy.

In some embodiments, the coating may include a layer comprising nickel (e.g., a nickel alloy such as nickel-tungsten). In some cases, the layer comprising nickel may be disposed between the base material and the silver-based alloy layer. In one embodiment, the coating comprises a first layer comprising nickel, a second layer comprising the silver-based alloy, and a third layer comprising one or more precious metals, where the first layer is formed on the base material, the second layer is formed on the first layer, and the third layer is formed on the second layer.

A layer of the coating may have any suitable thickness. In some embodiments, it may be advantageous for a layer to be thin, for example, to save on material costs. For example, a layer thickness may be less than 30 microinches (e.g., between about 1 microinch and about 30 microinches; in some cases, between about 5 microinches and about 30 microinches); in some cases the layer thickness may be less than 20 microinches (e.g., between about 1 microinch and about 20 microinches; in some cases, between about 5 microinches and about 20 microinches); and, in some cases, the layer thickness may be less than 10 microinches (e.g., between about 1 microinch and about 10 microinches; in some cases, between about 5 microinches and about 10 microinches). In some embodiments, the thickness of a layer is chosen such that the layer is essentially transparent on the surface. It should be understood that other layer thicknesses may also be suitable.

The second layer may cover the entire first layer. However, it should be understood that in other embodiments, the second layer covers only part of the first layer. In some cases, a second layer covers at least 50% of the surface area of a first layer; in other cases, at least 75% of the surface area of a first layer. In some cases, an element from a first layer may be incorporated within a second layer and/or an element from a second layer may be incorporated into a first layer.

In some embodiments, it may preferable for the first layer to be formed directly on the base material. Such embodiments may be preferred over certain prior art constructions that utilize a layer between the first layer and the base material because the absence of such an intervening layer can save on overall material costs. Though, it should be understood that in other embodiments, one or more layers may be formed between the first layer and the base material. For example, in some embodiments, a barrier layer may be formed between the base material and the first layer. The barrier layer, in some embodiments, comprises nickel. In some cases, the barrier layer comprises nickel-tungsten or sulfamate nickel.

In some embodiments, a lubricant layer may be formed as an upper portion of the coating. The lubricant layer may comprise, for example, an organic material, a self-assembled monolayer, carbon nanotubes, and the like. In some cases, the presence of a lubricant layer reduces the coefficient of friction of the coating as compared to a substantially similar coating but which does not include the lubricant layer. The lubricant layer may be formed of any suitable material, for example halogen-containing organic lubricant, a polyphenyl-containing organic lubricant, or a polyether-containing lubricant. In one embodiment, the lubricant layer is formed of a halogen-containing organic lubricant. Specific non-limiting examples of lubricants include Evabrite™ (Enthone), Au lube (AMP), NyeTact® 570H (Nye Lubricants), FS-5 (Gabriel Performance Products), S-30 (Gabriel Performance Products), and MS-383H (Miller-Stephenson). In some cases, the lubricant layer comprises a monolayer formed on the surface of the coating.

Those of ordinary skill in the art will be aware of suitable methods for forming a lubricant layer on a coating. For example, in some embodiments, an article comprising the coating may exposed (e.g., dipped into) to the lubricant (e.g., optionally in a solution), and the article may then be allowed to dry, thereby forming the lubricant layer on the upper portion of the coating.

In some embodiments, an article comprising a lubricant layer formed on coating (e.g., on a base material) may have a reduced coefficient of friction as compared to a substantially similar article which does not comprise the lubricant layer. In some cases, the article having the lubricant layer has a co-efficient of friction which is at least two times less, at least three times less, at least four times less, at least five times less, or at least ten times less than an article which not having the lubricant layer.

In some cases, an article having a lubricant layer may have better wear durability as compared to a substantially similar article which does not have a lubricant layer. Those of ordinary skill in the art will be aware of suitable methods to determine the wear durability of a material (e.g., ball-on-plate-type reciprocating friction abrasion test, wherein the ball and plate both are coated with a layer of the alloy, and optionally the lubricant layer). For example, in some embodiments, minimal or no wear-through may be observed for an article comprising a silver-based alloy and a lubricant layer over 50 cycles, 100 cycles, 250 cycles, 500 cycles, or 1000 cycles, with a 100 g applied load, wherein a substantially similar article which does not comprise the lubricant layer may show substantial or complete wear-through.

In some cases, the coating (e.g., the first layer and/or the second layer) may have a particular microstructure. For example, at least a portion of the coating may have a nanocrystalline microstructure. As used herein, a “nanocrystalline” structure refers to a structure in which the number-average size of crystalline grains is less than one micron. The number-average size of the crystalline grains provides equal statistical weight to each grain and is calculated as the sum of all spherical equivalent grain diameters divided by the total number of grains in a representative volume of the body. The number-average size of crystalline grains may, in some embodiments, be less than 100 nm. In some cases, the silver-based alloy has a number-average grain size less than 50% of a thickness of the silver-based alloy layer. In some instances, the number-average grain size may be less than 10% of a thickness of the silver-based alloy layer. In some embodiments, at least a portion of the coating may have an amorphous structure. As known in the art, an amorphous structure is a non-crystalline structure characterized by having no long range symmetry in the atomic positions. Examples of amorphous structures include glass, or glass-like structures. Some embodiments may provide coatings having a nanocrystalline structure throughout essentially the entire coating. Some embodiments may provide coatings having an amorphous structure throughout essentially the entire coating.

In some embodiments, the coating may be crystalline having a face-centered cubic structure. In some embodiments, the coating may be a solid solution where the metals comprising the coating are essentially dispersed as individual atoms. Such a structure may be produced using an electrodeposition process. A solid solution may be distinguished from an alternative structure formed, for example, using an electroless process where granules comprising a first phase containing a first metal species (i.e., tungsten and/or molybdenum) are dispersed within a coating comprising a second phase containing a second metal species (i.e., silver), the second phase having a different composition and/or crystal structure than the first phase. In some cases, the solid solution may be essentially free of oxygen.

In some embodiments, the coating may comprise various portions having different microstructures. For example, the first layer may have a different microstructure than the second layer. The coating may include, for example, one or more portions having a nanocrystalline structure and one or more portions having an amorphous structure. In one set of embodiments, the coating comprises nanocrystalline grains and other portions which exhibit an amorphous structure. In some cases, the coating, or a portion thereof (e.g., a portion of the first layer, a portion of the second layer, or a portion of both the first layer and the second layer), may comprise a portion having crystal grains, a majority of which have a grain size greater than one micron in diameter. In some embodiments, the coating may include other structures or phases, alone or in combination with a nanocrystalline portion or an amorphous portion. Those of ordinary skill in the art would be able to select other structures or phases suitable for use in the context of the invention.

Advantageously, the coating (i.e., the first layer, the second layer, or both the first layer and the second layer) may be substantially free of elements or compounds having a high toxicity or other disadvantages. In some instances, it may also be advantageous for the coating to be substantially free of elements or compounds that are deposited using species that have a high toxicity or other disadvantages. For example, in some cases, the coating is free of chromium (e.g., chromium oxide), which is often deposited using chromium ionic species that are toxic (e.g., Cr⁶⁺). In some cases, the coating may be deposited from an electrodeposition bath that is substantially free of cyanide. Such coating may provide various processing, health, and environmental advantages over certain previous coatings.

In some embodiments, the electrodeposited coating (e.g., alloy) may be porous. In some cases, the coating has a porosity of at least 5%, at least 10%, at least 15%, at least 20%, at least 25%, at least 30%, or at least 50%. In some cases, the coating has a porosity between about 5% and about 30%, or between about 10% and about 25%. In some cases, for a silver-based alloy comprising tungsten and/or molybdenum, the porosity may vary and/or be controlled based upon the percent tungsten contained in the alloy. In a particular embodiment, for a silver-based alloy comprising tungsten and/or molybdenum in at least 1.5 atomic percent, the coating has a porosity of at least about 10%, or between about 10% and about 25%.

Those of ordinary skill in the art will be aware of methods to determine the porosity of a coating (e.g., alloy), including, but not limited to, direct measurement of porosity by optical and/or density methods. In some cases, the porosity may be determined using optical methods, wherein the porosity is determined by obtaining an image of the cross section of the coating and calculating the area of pores (e.g., which may be observed, in some cases, as dark spots). With the assumption that the pores are homogenous throughout the coating, a volume fraction of pores can be calculated.

In some embodiments, metal, non-metal, and/or metalloid materials, salts, etc. (e.g., phosphate or a redox mediator such as potassium ferricyanide, or fragment thereof) may be incorporated into the coating.

The composition of the coatings, or portions or layers thereof, may be characterized using suitable techniques known in the art, such as Auger electron spectroscopy (AES), X-ray photoelectron spectroscopy (XPS), etc. For example, AES and/or XPS may be used to characterize the chemical composition of the surface of the coating.

The coating may have any thickness suitable for a particular application. For example, the coating thickness may be greater than about 1 microinch (e.g., between about 1 microinch and about 100 microinches, between about 1 microinch and 50 microinches); in some cases, greater than about 5 microinches (e.g., between about 5 microinches and about 100 microinches, between about 5 microinches and 50 microinches); greater than about 25 microinches (e.g., between about 25 microinches and about 100 microinches, between about 1 microinch and 50 microinches). It should be understood that other thicknesses may also be suitable. In some embodiments, the thickness of the coating is chosen such that the coating is essentially transparent on the surface. Thickness may be measured by techniques known to those of ordinary skill in the art.

Base material 30 may be coated to form coated articles, as described above. In some cases, the base material may comprise an electrically conductive material, such as a metal, metal alloy, intermetallic material, or the like. Suitable base materials include steel, copper, aluminum, brass, bronze, nickel, polymers with conductive surfaces and/or surface treatments, transparent conductive oxides, amongst others. In some embodiments, copper base materials are preferred.

The articles can be used in a variety of applications including electrical applications such as electrical connectors (e.g., plug-type). In some embodiments, the coating on an electrical connector includes a first layer comprising a silver alloy, the first layer disposed on a base material, and a second layer comprising a precious metal, the second layer disposed on the first layer. The coating can impart desirable characteristics to an article, such as durability, hardness, corrosion resistance, thermal stability, and reduced electrical resistivity. These properties can be particularly advantageous for articles in electrical applications such as electrical connectors, which may experience rubbing or abrasive stress upon connection to and/or disconnection from an electrical circuit that can damage or otherwise reduce the conductivity of a conductive layer on the article. Non-limiting examples of electrical connectors include infrared connectors, USB connectors, battery chargers, battery contacts, automotive electrical connectors, etc. In some embodiments, the presence of the first layer of a coating may provide at least some of the durability and corrosion resistance properties to the coating. In some embodiments, the coating may impart decorative qualities, for example a blue tint and reduced tarnish. Additionally, the presence of the first layer may allow the thickness of the second layer to be reduced, thereby reducing the amount of precious metal on the article significantly.

The coatings described herein may impart advantageous properties to an article, such as an electrical connector. In some embodiments, the coating, or layer of the coating, may have a low electrical resistivity. For example, the electrical resistivity may be less than 100 microohm-centimeters, less than 50 microohm-centimeters, less than 10 microohm-centimeters, or less than 2 microohm-centimeters.

The coating or layer of the coating may have a hardness of at least 1 GPa, at least 1.5 GPa, at least 2 GPa, at least 2.5 GPa, or at least 3 GPa, or between about 2.0 GPa and about 3.0 GPa. Those of ordinary skill in the art would readily be able to measure these properties. In some cases, a coating comprising a silver-based alloy and a lubricant layer may have a hardness of at least 1 GPa, at least 1.5 GPa, at least 2 GPa, at least 2.5 GPa, or at least 3 GPa and a coefficient of friction of less than about 1.0, less than about 0.75, less than about 0.5, less than about 0.4, less than about 0.3, less than about 0.2, or less than about 0.1. In some embodiments, the hardness is between about 2.0 GPa and about 3.0 GPa, and the coefficient of friction is less than about 0.3, or between about 0.3 and about 0.1.

The coating or layer of the coating may be thermally stable. In some cases, a coating comprising a silver-based alloy further comprising tungsten and/or molybdenum and having a grain size of less than about 100 nm, exhibits little or no change in grain size upon exposure to elevated temperatures for a substantial period of time. In some cases, the grain size of the coating changes by no more than about 30 nm, no more than about 20 nm, no more than about 15 nm, no more than about 10 nm, or no more than about 5 nm following exposure to a temperature of at least 125° C. for at least 1000 hours. In some cases, the grain size changes by no more than about 30 nm, no more than about 20 nm, no more than about 15 nm, no more than about 10 nm, or no more than about 5 nm following exposure to a temperature of about 125° C. for at least about 1000 hours. The thermal stability may be determined under other suitable conditions, for example, at about 150° C. for at least about 24 hours, at about 200° C. for at least about 24 hours, at about 250° C. for at least about 24 hours, or at about 200° C. for at least about 120 hours. In addition, the contract resistance of the coating may change by less than about 25%, less than about 20%, less than about 15%, less than about 10%, or less than about 5%, following exposure to a temperature of about 125° C. for at least about 1000 hours.

Those of ordinary skill in the art will be aware of suitable methods to determine the thermal stability of a material. In some cases, the thermal stability may be determined by observing microstructural changes (e.g., grain growth, phase transition, etc.) of a material during and/or prior to and following exposure to heat. Thermal stability may be determined using differential scanning calorimetry (DSC) or differential thermal analysis (DTA), wherein a material is heating under controlled conditions. To determine changes in grain size and/or phase transitions, in situ x-ray experiments may be conducting during the heating process.

As noted above, coating 20 may be formed using an electrodeposition process. In some cases, each layer of the coating may be applied using a separate electrodeposition bath. In some cases, individual articles may be connected such that they can be sequentially exposed to separate electrodeposition baths, for example in a reel-to-reel process. For instance, articles may be connected to a common conductive substrate (e.g., a strip). In some embodiments, each of the electrodeposition baths may be associated with separate anodes and the interconnected individual articles may be commonly connected to a cathode.

In some embodiments, the invention provides coated articles that are capable of resisting corrosion, and/or protecting an underlying substrate material from corrosion, in one or more potential corrosive environments. Examples of such corrosive environments include, but are not limited to, aqueous solutions, acid solutions, alkaline or basic solutions, or combinations thereof. For example, coated articles described herein may be resistant to corrosion upon exposure to (e.g., contact with, immersion within, etc.) a corrosive environment, such as a corrosive liquid, vapor, or humid environment.

The corrosion resistance may be assessed using tests such as ASTM B845, entitled “Standard Guide for Mixed Flowing Gas (MFG) Tests for Electrical Contacts” following the Class IIa protocol, may also be used to assess the corrosion resistance of coated articles. These tests outline procedures in which coated substrate samples are exposed to a corrosive atmosphere (i.e., a mixture of NO₂, H₂S, Cl₂, and SO₂). The mixture of flowing gas can comprise 200+/−50 ppb of NO₂, 10+/−5 ppb of H₂S, 10+/−3 ppb of Cl₂, and 100+/−20 ppb SO₂. The temperature and relative humidity may also be controlled. For example, the temperature may be 30 +/−1° C., and the relative humidity may be 70+/−2%.

The low-level contact resistance of a sample may be determined before and/or after exposure to a corrosive environment for a set period of time according to one of the tests described above. In some embodiments, the low-level contact resistance may be determined according to specification EIA 364, test procedure 23. Generally, the contact resistivity of a sample may be measured by contacting the sample under a specified load and current with a measurement probe having a defined cross-sectional area of contact with the sample. For example, the low-level contact resistance may be measured under a load of 25 g, 50 g, 150 g, 200 g, etc. Generally, the low-level contact resistance decreases as the load increases.

In some embodiments, a coated article has reduced low-level contact resistance. Reduced low-level contact resistance may be useful for articles used in electrical applications such as electrical connectors. In some cases, an article may have a low-level contact resistance under a load of 25 g of less than about 100 mOhm; in some cases, less than about 10 mOhm; in some cases, less than about 5 mOhm; and, in some cases, less than about 1 mOhm. It should be understood that the article may have a low-level contact resistance outside this range as well. It should also be understood that the cross-sectional area of contact by the measurement probe may affect the value of the measured low-level contact resistance.

The following example should not be considered to be limiting but illustrative of certain features of the invention.

### EXAMPLES

### Example 1

This example demonstrates coating thickness, tungsten content, grain size, coating hardness, and contact resistance achieved with various samples.

Coatings were electrodeposited on base materials in aqueous electrodeposition baths using an electrodeposition process. The electrodeposition baths contained a silver ionic species, a tungsten ionic species, and a complexing agent. The coatings were formed directly on the base material substrate. Additionally, for samples 28-35, a nickel layer was electrodeposited on the substrate prior to electrodepositing the silver-based alloy.

Tables 1 and 2 show the results obtained for these coatings.

TABLE 1
Thickness, tungsten content, grain size and hardness
for various samples.

| | Thickness | Tungsten | Grain | Hardness |
|---|---|---|---|---|
| Sample | (microns) | (atomic %) | Size (nm) | (GPa) |
| 1 | 2.9 | 1.0 | 22 | 2.4 |
| 2 | 3.1 | 1.5 | 20 | N.D. |
| 3 | 3.4 | 1.4 | 15 | N.D. |
| 4 | 3.8 | 1.7 | 14 | 2.4 |
| 5 | 3.7 | 7.9 | 5 | 2.2 |
| 6 | 3.8 | 7.7 | 5 | 2.1 |
| 7 | 4.2 | 7.1 | 6 | N.D. |
| 8 | 4.1 | 6.4 | 7 | 1.6 |
| 9 | N.D. | 1.2 | N.D. | N.D. |
| 10 | 3.1 | 1.2 | 96 | 2.1 |
| 11 | 4.5 | 1.6 | N.D. | N.D. |
| 12 | 4.5 | 1.3 | 49 | N.D. |
| 13 | 9.8 | 1.4 | 55 | 2.6 |
| 14 | 7.5 | 1.4 | 49 | N.D. |
| 15 | 6.4 | 4.9 | 10 | 2.9 |
| 16 | 8.2 | 3.1 | 25 | 2.8 |
| 17 | 7.9 | 4.6 | 10 | 1.8 |
| 18 | 2.4 | 1.8 | 35 | 2.4 |

N.D. = not determined.

TABLE 2
Substrate, tungsten content, and contact resistance
for various samples.

| | | Tungsten | Contact Resistance |
|---|---|---|---|
| Sample | Substrate | (atomic %) | (milliohms) |
| 19 | brass | 1.3 | 4.6 |
| 20 | brass | 1.5 | 4.2 |
| 21 | brass | 2.9 | 6.8 |
| 22 | brass | 6.9 | 8.8 |
| 23 | brass | 7.0 | 7.2 |
| 24 | brass | 1.6 | 5.9 |
| 25 | brass | 1.9 | 5.3 |
| 26 | brass | 7.3 | 10.4 |
| 27 | brass | 5.5 | N.D. |
| 28 | Ni/brass | 1.8 | 7.7 |
| 29 | Ni/brass | 2.3 | 6.6 |
| 30 | Ni/brass | 6.8 | 8.4 |
| 31 | Ni/brass | 5.5 | 10.4 |
| 32 | Ni/brass | 0.9 | 6.6 |
| 33 | Ni/brass | 1.5 | 5.9 |
| 34 | Ni/brass | 6.7 | 8.4 |
| 35 | Ni/brass | 7.4 | 8.0 |

N.D. = not determined.

### Example 2

This example demonstrates coating wear durability for a material which comprises a lubricant layer.

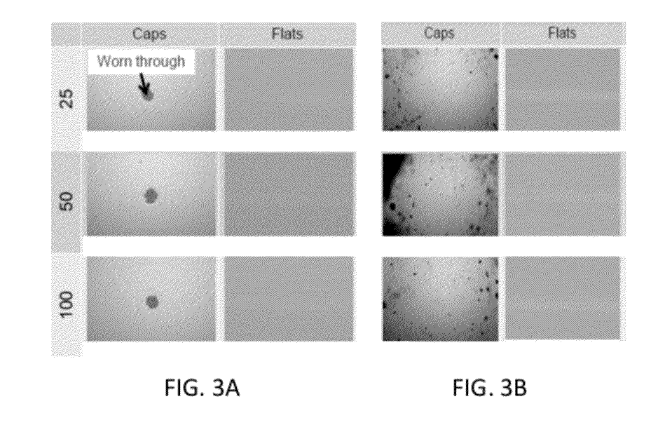

A silver-tungsten alloy was electrodeposited as described above in Example 1, on two round surfaces and two flat surfaces. The alloy comprised about 5 wt % tungsten and the thickness of the coating was about 80 microinches. The hardness of the coating was about 2.0-2.5 GPa. Following electrodeposition, a lubricant was formed on one of the round surfaces and one of the flat surfaces using simple dip application methods known to those in the art. In this example, the lubricant was Evabrite™. Wear durability studies were conducting as follows: a coated round surface was placed in contact with a coated flat surface; the flat and round surfaces were then worn against each other through a linear reciprocating motion As shown in FIG. 3, the article which did not include the lubricant layer (FIG. 3A) showed significant wear-through after 25 cycles while the article which included the lubricant layer (FIG. 3B) showed essentially no wear-through, even after 100 cycles. The coefficient of friction for the article without the lubricant layer was about 1.0, whereas the coefficient of friction for the article including the lubricant layer was about 0.2.

### Example 3

This example demonstrates changes in the porosity of an electrodeposited coating comprising a silver alloy having varying weight percentages of tungsten.

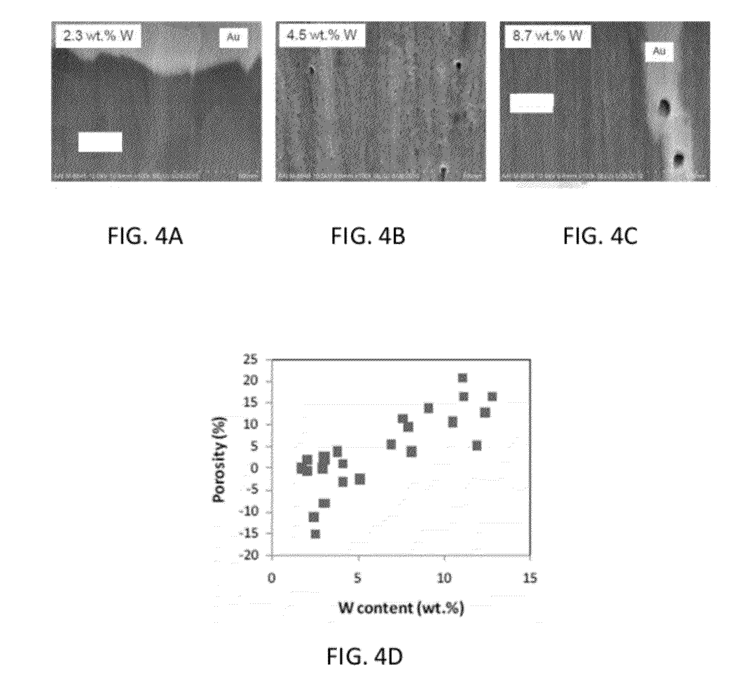

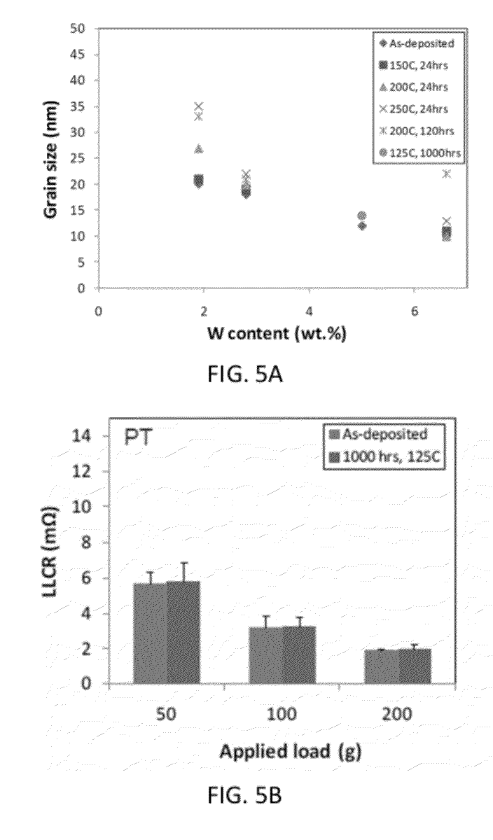

FIGS. 4A-4C show scanning electron micrographs of cross sections of silver-tungsten alloys electrodeposited according to the methods described in Example 1, comprising A) 2.3 wt %, B) 4.5 wt %, and C) 8.7 wt %. FIG. 4D shows a plot of the porosity versus wt % of tungsten for electrodeposited silver-tungsten alloys, according to some embodiments.

### Example 4

This example demonstrates the use of electrodeposition baths containing at least one brightening agent.

Silver-tungsten alloys were electrodeposited according to the methods described in Example 1. In a first case, the bath contained a 2,2-bipyridine brightening agent at a concentration of between about 0.2 g/L and 0.5 g/L. The 2,2-bipyridine was dissolved in ethylene glycol prior to addition of the brightening agent to the bath. In another case, the bath contained a 3-formyl-1-(3-sulphanatopropyl)pyridinium brightening agent was at a concentration of about 2 g/L. In both cases, the coatings were bright at all current densities.

### Example 5

This example demonstrates thermal stability of a silver-tungsten alloy.

A silver-tungsten alloy coating was electrodeposited on a base material as described above in Example 1 comprising a variety of weight percentages of tungsten. The articles were exposed to elevated temperatures for selected periods of time. FIG. 5A shows a plot of the grain size (nm) versus tungsten weight percent for the alloys. FIG. 5B shows a plot of the contact resistance versus applied load for the a silver-tungsten coating with Evabrite™ lubricant applied which was heated to 125° C. for 1000 hours.

### Example 6

This example demonstrates variation of the ratio of cathode to anode surface areas.

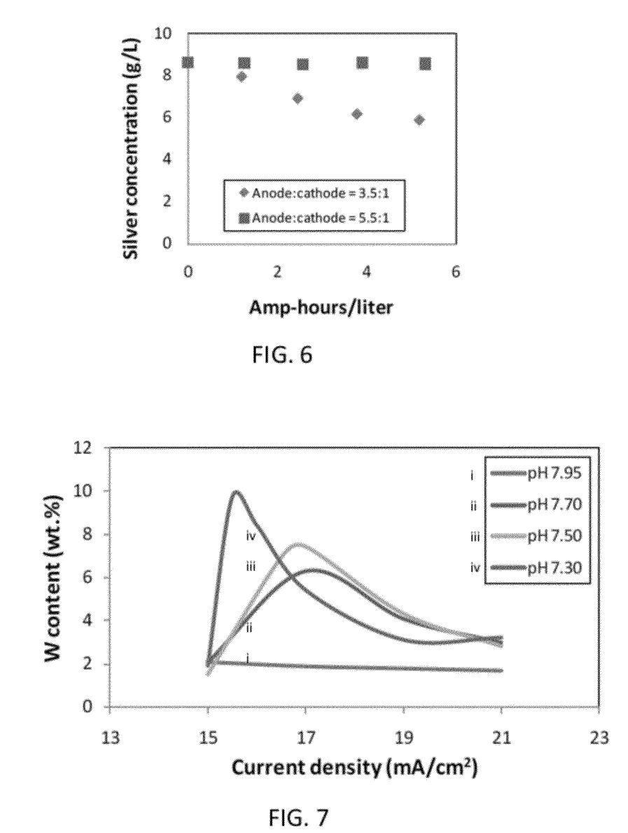

Silver-tungsten alloy coatings were electrodeposited on a base material as described above in Example 1, wherein the silver ionic species were provided to the bath from a consumable silver anode. In this example, the surface area of the anode was 3.5 or 5 times the surface area of the cathode. At a surface area ratio of anode:cathode of 3.5:1, the anode passivated and the silver ionic species in the solution were not replenished. At a surface area ratio of anode:cathode of 5:1, the silver concentration remained approximately constant (see FIG. 6).

### Example 7

This example demonstrates variation of the pH of an electrodeposition bath and its relation to tungsten content in the alloy.

A silver-tungsten alloy coating was electrodeposited on a base material as described above in Example 1. The pH of the electrodeposition bath was adjusted using sodium hydroxide. A plot of the tungsten content versus current density is shown in FIG. 7.

### Example 8

This example demonstrates variation of the additive to adjust the pH of the electrodeposition bath.

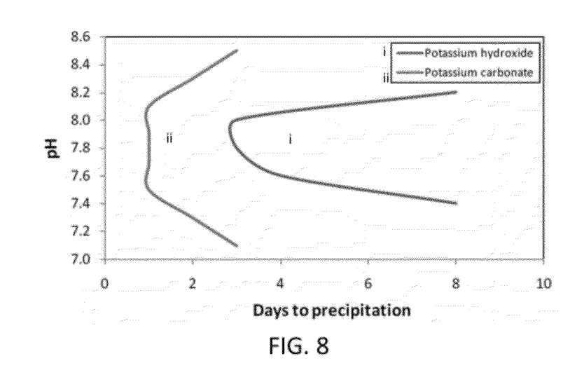

Silver-tungsten alloy coatings were electrodeposited from various baths on base materials as described above in Example 1. The pH of the electrodeposition baths were adjusted using sodium hydroxide, sodium carbonate, potassium hydroxide, or potassium carbonate. No precipitation (e.g., of tungsten oxide) was observed for the bath containing sodium hydroxide or sodium carbonate. In contrast, precipitation was observed in the baths containing potassium hydroxide or potassium carbonate (see FIG. 8).

What is claimed:

1. An article, comprising:
a base material; and
a coating formed on the base material, the coating comprising a silver-based alloy, the silver-based alloy further comprising tungsten and/or molybdenum, the silver-based alloy having a grain size of less than about 100 nm, wherein the grain size changes by no more than 30 nm following exposure to a temperature of at least 125° C. for at least 1000 hours.

2. The article as in claim 1, wherein the article is an electrical component.

3. The article as in claim 2, wherein the base material is a conductive base material.

4. The article as in claim 1, wherein the silver-based alloy is between 0.1 atomic percent and 50 atomic percent tungsten and/or molybdenum.

5. The article as in claim 1, wherein the coating has a thickness greater than about 5 microinches.

6. The article as in claim 1, wherein the grain size changes by no more than about 20 nm.

7. The article as in claim 1, wherein the coating is formed using an electrodeposition process.

8. The article as in claim 1, wherein the coating is formed in a bath.

9. The article as in claim 1, wherein the base material comprises copper.

10. The article as in claim 1, wherein the coating further comprises a layer comprising nickel.

11. The article as in claim 1, wherein the coating further comprises a layer comprising Ru, Os, Rh, Re, Ir, Pd, Pt, Ag, Au, or a combination thereof.

12. An article, comprising:
a base material;
a coating formed on the base material, the coating comprising a silver-based alloy, the silver-based alloy further comprising tungsten and/or molybdenum, wherein the concentration of tungsten and/or molybdenum in the silver-based alloy in at least 1.5 atomic percent and the silver-based alloy has an average grain size of less than 1 micron; and
a lubricant layer formed on the coating.

13. The article as in claim 12, wherein the article is an electrical component.

14. The article as in claim 13, wherein the base material is a conductive base material.

15. The article as in claim 12, wherein the silver-based alloy is between 1.5 atomic percent and 50 atomic percent tungsten and/or molybdenum.

16. The article as in claim 12, wherein the coating has a thickness greater than about 5 microinches.

17. The article as in claim 12, wherein the lubricant layer is a halogen-containing lubricant, a polyphenyl-containing lubricant, or a polyether-containing lubricant

18. The article as in claim 12, wherein the coating is formed using an electrodeposition process.

19. The article as in claim 12, wherein the coating is formed in a bath.

20. The article as in claim 12, wherein the base material comprises copper.

21. The article as in claim 12, wherein the coating further comprises a layer comprising nickel.

22. The article as in claim 12, wherein the coating further comprises a layer comprising Ru, Os, Rh, Re, Ir, Pd, Pt, Ag, Au, or a combination thereof.

23. The article as in claim 12, wherein the article has a co-efficient of friction which is at least two times less than an article which does not comprise the lubricant layer.

24. The article as in claim 12, wherein the article has a co-efficient of friction which is at least three times less than an article which does not comprise the lubricant layer.

25. An article, comprising:
a base material;
a coating formed on the base material, the coating comprising a silver-based alloy, the silver-based alloy further comprising tungsten and/or molybdenum; and
a lubricant layer formed on the coating,
wherein the hardness of the article is greater than about 1 GPa and the coefficient of friction is less than about 0.3.

26. The article as in claim 25, wherein the article is an electrical component.

27. The article as in claim 26, wherein the base material is a conductive base material.

28. The article as in claim 25, wherein the silver-based alloy is between 0.1 atomic percent and 50 atomic percent tungsten and/or molybdenum.

29. The article as in claim 25, wherein the coating has a thickness greater than about 5 microinches.

30. The article as in claim 25, wherein the hardness of the alloy is between about 1.5 GPa and about 3.0 GPa.

31. The article as in claim 25, wherein the coating is formed using an electrodeposition process.

32. The article as in claim 25, wherein the coating is formed in a bath.

33. The article as in claim 25, wherein the base material comprises copper.

34. The article as in claim 25, wherein the coating further comprises a layer comprising nickel.

35. The article as in claim 25, wherein the coating further comprises a layer comprising Ru, Os, Rh, Re, Ir, Pd, Pt, Ag, Au, or a combination thereof.

36. The article as in claim 25, wherein the article has a co-efficient of friction which is at least two times less than an article which does not comprise the lubricant layer.

37. The article as in claim 25, wherein the article has a co-efficient of friction which is at least three times less than an article which does not comprise the lubricant layer.

38. An article, comprising:
a base material; and
a coating formed on the base material, the coating comprising a silver-based alloy, the silver-based alloy further comprising tungsten and/or molybdenum in at least 1.5 atomic percent,
wherein the coating has a porosity of at least 10%.

39. The article as in claim 38, wherein the coating has a porosity between about 10% and about 25%.

40. The article as in claim 38, wherein the article is an electrical component.

41. The article as in claim 40, wherein the base material is a conductive base material.

42. The article as in claim 38, wherein the silver-based alloy is between 0.1 atomic percent and 50 atomic percent tungsten and/or molybdenum.

43. The article as in claim 38, wherein the coating has a thickness greater than about 5 microinches.

44. The article as in claim 38, wherein the silver-based alloy has a face-centered cubic structure.

45. The article as in claim 38, wherein the coating is formed using an electrodeposition process.

46. The article as in claim 38, wherein the coating is formed in a bath.

47. The article as in claim 38, wherein the base material comprises copper.

48. The article as in claim 38, wherein the coating further comprises a layer comprising nickel.

49. The article as in claim 38, wherein the coating further comprises a layer comprising Ru, Os, Rh, Re, Ir, Pd, Pt, Ag, Au, or a combination thereof.
